(19) United States
(12) Patent Application Publication
(10) Pub. No.: US 2011/0022305 A1
(43) Pub. Date: Jan. 27, 2011

(54) CAR NAVIGATION APPARATUS, A PORTABLE INFORMATION TERMINAL AND A CAR NAVIGATION SYSTEM

(76) Inventor: Keisuke Okamoto, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/936,092

(22) PCT Filed: Mar. 27, 2009
(86) PCT No.: PCT/JP09/56309

§ 371 Date: Oct. 1, 2010

(30) Foreign Application Priority Data
Apr. 1, 2008 (JP) 2008-094962

(51) Int. Cl. G01C 21/36

(52) U.S. Cl. 701/201; 701/200

(57) ABSTRACT

A car navigation apparatus is installed in a vehicle and performs a setting of a destination to be guided based on information received from a portable information terminal. The car navigation apparatus a receiving portion that receives, from the portable information terminal, destination information, which is obtained utilizing a contents server to which the portable information terminal is connected via a network, and date and time information, which is input at the time of utilizing the contents server; and a destination setting portion that sets the destination based on the destination information and the date and time information received by the receiving portion.

### TECHNICAL FIELD

The present invention is related to a car navigation apparatus, a portable information terminal and a car navigation system.

### BACKGROUND ART

Such service linking a mobile phone and a car navigation apparatus becomes widespread in which a user can search for and display POI (Point of Interest) information of a restaurant, a facility, etc., using a web browser of the mobile phone, etc., input the POI information in the car navigation apparatus at the time of entering the vehicle using an infrared communication function which the mobile phone has, in order to perform setting of a destination in the car navigation apparatus based on position information of the POI information. The location of the POI information can be set as a destination in the car navigation apparatus by transmitting the POI information as it is after searching for and displaying the information using the portable terminal, etc. Thus, there are merits that an occupant of the vehicle who is going to the destination from this time on feels convenience, and information which is not registered in the car navigation apparatus, such as information on a new shop, can easily be input.

As an invention related to this, JP2003-315078 A discloses a car navigation apparatus which extracts telephone number information from a HTML (Hyper Text Markup Language) file received from the portable terminal and performs setting of a destination, registration of a location, etc., using the extracted telephone number information. According to the invention disclosed in JP2003-315078 A, setting of a destination in the car navigation apparatus can be performed using POI information obtained from the portable terminal.

However, in the invention disclosed in JP2003-315078 A, a data transmission from the mobile phone to the car-mounted navigation apparatus is performed manually. Thus, it is inconvenient because a user cannot start to drive the vehicle until the operation of the data transmission is completed. Further, in the above described services, the data may be transmitted automatically; however, if the data may be transmitted automatically, a destination to which the user does not go in fact may be set. Further, if there are several candidates of the destination as the result of the search, it is difficult to automatically select and set one of the candidates appropriately. This results from the following facts (1)-(3), etc., in the case of automatically transmitting the information from the mobile phone to the navigation apparatus to perform setting of the destination:

(1) when the user intends to go to the destination is not considered;

(2) how much intention of going to the destination the user has is not considered; and

(3) in the case of several candidates of the destination, a probability or a priority, such as that which of the candidates is likely to be intended, is not considered.

### SUMMARY OF INVENTION

Therefore, an object of the present invention is to provide a car navigation apparatus and a car navigation system which automatically receives destination information from a portable information terminal and performs setting of a destination to which a user goes from this time on with a high probability. Further, an object of the present invention is to provide a portable information terminal which automatically transmits destination information on a destination, to which a user goes from this time on with a high probability, to perform setting of a destination in a car navigation apparatus.

In order to achieve the aforementioned objects, a car navigation apparatus according to the first aspect of the present invention is installed in a vehicle and performs a setting of a destination to be guided based on information received from a portable information terminal, said car navigation apparatus comprising:

receiving means for receiving, from the portable information terminal, destination information, which is obtained utilizing a contents server to which the portable information terminal is connected via a network, and date and time information, which is input at the time of utilizing the contents server; and

destination setting means for setting the destination based on the destination information and the date and time information received by the receiving means.

According to the second aspect of the present invention, in the first aspect of the present invention,

the receiving means receives communication history information related to the destination information, said communication history information being obtained by the portable information terminal from a communication history of the portable information terminal, and

the destination setting means sets the destination based on the destination information, the date and time information and the communication history information.

According to the third aspect of the present invention, in the first or the second aspect of the present invention,

the receiving means automatically receives the information from the portable information terminal when an engine of the vehicle is started.

According to the fourth aspect of the present invention, a portable information terminal is provided which transmits information on contents which said portable information terminal obtains using a contents server to which said portable information terminal is connected via a network, and performs a destination setting of a navigation apparatus, said portable information terminal comprising:

information extracting means for extracting destination information from information on contents, and day and time information, which is input at the time of utilizing the contents server; and

set destination determining means for determining a destination set in the car navigation apparatus based on the destination information and the day and time information extracted by the information extracting means; and

transmitting means for transmitting information on the set destination to the car navigation apparatus, said set destination being determined by the set destination determining means.

According to the fifth aspect of the present invention, in the fourth aspect of the present invention,

the information extracting means extracts communication history information related to the destination information, said communication history information being extracted from a communication history of the portable information terminal; and

the set destination determining means determines the set destination based on the destination information, the date and time information and the communication history information.

According to the sixth aspect of the present invention, in the fourth or the fifth aspect of the present invention,

the transmitting means automatically transmits the information extracted by the information extracting means when the transmission is demanded by the car navigation apparatus.

According to the seventh aspect of the present invention, a car navigation system comprises a portable information terminal which transmits information on contents which said portable information terminal obtains using a contents server to which said portable information terminal is connected via a network; and a navigation apparatus which performs a setting of a destination to be guided based on the information on contents which is received from the portable information terminal, wherein

the portable information terminal comprising:

information extracting means for extracting destination information from information on contents, and day and time information, which is input at the time of utilizing the contents server; and

transmitting means for transmitting the destination information and the day and time information to the car navigation apparatus, said set destination being extracted by the information extracting means, and

the car navigation apparatus comprising:

receiving means for receiving the destination information and the day and time information from the portable information terminal; and

destination setting means for setting the destination based on the destination information and the date and time information received by the receiving means.

According to the eighth aspect of the present invention, in the seventh aspect of the present invention,

in the portable information terminal:

the information extracting means extracts communication history information related to the destination information, said communication history information being extracted from a communication history of the portable information terminal; and

the transmitting means transmits the communication history information, and

in the car navigation apparatus:

the receiving means receives the communication history information; and

the destination setting means sets the destination based on the destination information, the date and time information and the communication history information.

According to the ninth aspect of the present invention, in the seventh or the eighth aspect of the present invention,

the transmitting means of the portable information terminal automatically transmits the information extracted by the information extracting means when an engine of the vehicle is started.

According to the present invention, it is possible to provide a car navigation apparatus and a car navigation system which automatically receives destination information from a portable information terminal and performs setting of a destination to which a user goes from this time on with a high probability. Further, according to the present invention, it is possible to provide a portable information terminal which automatically transmits destination information on a destination, to which a user goes from this time on with a high probability, to perform setting of a destination in a car navigation apparatus.

### BRIEF DESCRIPTION OF DRAWINGS

FIG. 1 is a diagram explaining a car navigation system 1 according to the present invention;

FIG. 2 is a system diagram of an embodiment of a car navigation apparatus 2 according to the present invention;

FIG. 3 is a functional block diagram illustrating main components of an embodiment of the car navigation system 1 according to the present invention including the car navigation apparatus 2 and a portable information terminal 3;

FIG. 4 is a flowchart illustrating an example of a main process implemented by the embodiment of the car navigation system 1;

FIG. 5 is a diagram illustrating an example of potential destination information;

FIG. 6 is a flowchart explaining destination determination;

FIG. 7 is a diagram illustrating an example of setting of a destination by the car navigation system 1 according to the embodiment;

FIG. 8 is a functional block diagram illustrating main components of an embodiment of the car navigation system 1 according to the present invention including the car navigation apparatus 2 and a portable information terminal 3;

FIG. 9 is a flowchart illustrating an example of a main process implemented by the variant of the car navigation system 1; and

FIG. 10 is a flowchart explaining a set destination determination.

### EXPLANATION FOR REFERENCE NUMBERS

1 car navigation system
2 car navigation apparatus
3 portable information terminal
4 web server
5 mobile phone network/Internet
201 CPU
202 communication apparatus
203 ROM
204 RAM
205 auxiliary storage
206 interface apparatus
208 GPS receiver
208 gyro sensor
209 input apparatus
210 display apparatus
211 speech output apparatus
212 sensor
301 trigger obtaining part
302 communication part
303 destination determining part
304 navigating part
305 vehicle controlling part
302 communication part
311 browsing part
312 information extracting part
313 storing part
314 transfer controlling part
501 candidate destination name
502 location information
503 telephone number
504 mail address
505 input information
506 communication history information
801 set destination determining part

### BEST MODE FOR CARRYING OUT THE INVENTION

In the following, the best mode for carrying out the present invention will be described in detail by referring to the accompanying drawings.

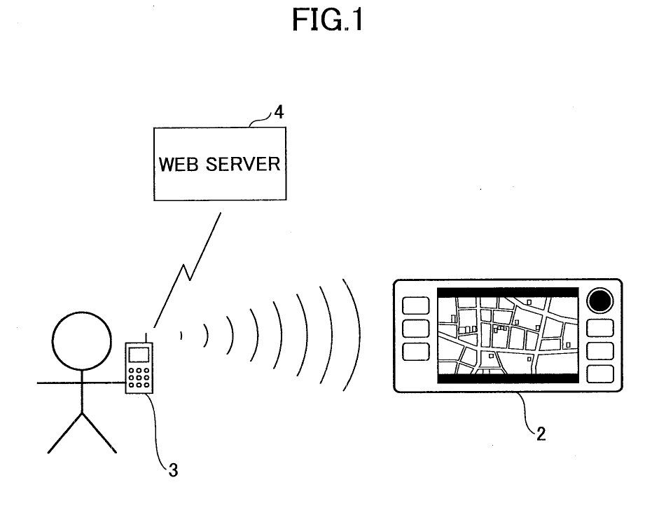

At first, an overall configuration of a car navigation system 1 is described briefly. FIG. 1 is a diagram explaining a car navigation system 1 according to the present invention. A user (a driver or a passenger) searches for POI information of a restaurant, a facility, etc., from a web server 4, which is a contents server having POI information, via a mobile phone network/Internet 5 and displays it on a screen, using the portable information terminal 3. Further, for example, the user reserves the restaurant with a reservation form from the screen searched using a portable information terminal 3. Or, the user telephones to the restaurant using the telephone number of the restaurant described in the screen searched using a portable information terminal 3 to have communication with the restaurant, etc. Next, when the user enters the vehicle, the user uses a Bluetooth communication function or an infrared communication function of the portable information terminal 3 to automatically transfer the POI information to the car navigation apparatus 2. A destination in the car navigation apparatus 2 is set based on location information (position information) of the POI information input to the car navigation apparatus 2. At that time, the car navigation apparatus 2 according to the present invention automatically receives destination information from the portable information terminal 3 and sets the destination to which the driver goes with a high probability from this time on. Hereafter, the car navigation system 1, the car navigation apparatus 2 and the portable information terminal 3 are described in detail.

[Configuration]

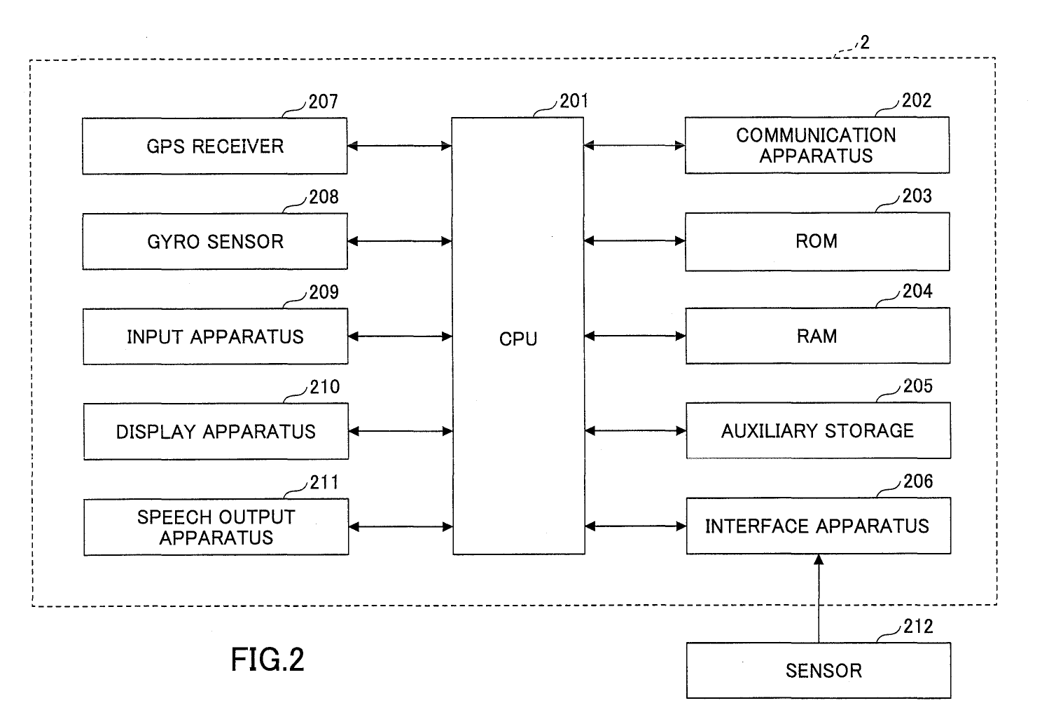

FIG. 2 is a system diagram of an embodiment of a car navigation apparatus 2 according to the present invention. The car navigation apparatus 2 includes, as its main components, a CPU 201, a communication apparatus 202, a ROM (Read Only Memory) 203, a RAM (Random Access Memory) 204, an auxiliary storage 205, an interface apparatus 206, a GPS receiver 207, a gyro sensor 208, an input apparatus 209, a display apparatus 210 and a speech output apparatus 211. Further, for example, the car navigation apparatus 2 is configured to receive the respective signals from sensors 212 such as a vehicle speed sensor.

The car navigation apparatus 2 according to the present invention has a function of detecting the current position of the vehicle (referred to as an “own vehicle position”, hereafter) and displaying a road map around the own vehicle position, a function of calculating a recommended route from a starting point to the destination, a function of performing route guidance based on the calculated recommended route, etc. In other words, the car navigation apparatus 2 is an apparatus for performing so called navigation or road guidance. The car navigation apparatus 2 outputs a destination, the current vehicle position, a travel route to the destination, a distance, an estimated time, etc., on a display screen, etc., based on received information from GPS (Global Positioning System) satellites and detailed map information in a map database. Further, the car navigation apparatus 2 displays traffic information on a display screen, etc., based on traffic information received from VICS (Vehicle Information Communication System). Further, the car navigation apparatus 2 performs setting of a destination based on the POI information received via the communication apparatus 202.

The CPU 201 and computer peripheral devices control the car navigation apparatus 2 as a whole. Further, the ROM 203 is a memory which stores a predetermined control program (software product) to be executed by the CPU 201. The RAM 204 is a memory used as a work area by the CPU 201 in performing various controls by executing the predetermined control program (software product) stored in the ROM 203. Thus, the CPU 201 performs a predetermined route search process based on the map data stored in a predetermined memory area, and the process result is displayed as the recommended route.

The auxiliary storage 205 is an apparatus for storing various information such as road map data (map data base), POI (Point of Interest: information of a tourist attraction or various facilities), etc., which is used in a car navigation application or a navigation process. A HDD (Hard Disk Drive) which is a nonvolatile memory is used as the auxiliary storage 205. It is noted that the above described various information may be stored in a storage medium other than the auxiliary storage 205 such as CD-ROM (Compact Disk ROM), DVD (Digital Versatile Disk), etc. The information stored in these storage media can be read via a drive apparatus. Thus, the information can be obtained by setting the storage medium in the drive apparatus if necessary.

Further, the road map data is information related to a map. The road map data consists of data for displaying a map, data for searching for a route, guidance data (an intersection name, a road name, a destination name, direction guidance facility information, etc), etc. The data for displaying a map is data for displaying roads and background of the road map. The data for searching for a route is data consisting of branch information which is not directly related to a road shape, etc. The data for searching for a route is used mainly in calculating (route search) the recommended route. The guidance data is data consisting of a name of an intersection, etc. The guidance data is used in guiding along the recommended route for the driver, etc., based on the calculated recommended route.

The interface apparatus 206 is an apparatus for performing bi-directional data communications via a data transmission line (not shown) between an external system configured by other apparatuses (external apparatuses) installed in the vehicle and the car navigation apparatus 2. Thus, by obtaining predetermined information from the external system, new information is available for the car navigation apparatus 2 (i.e., functional extension can be implemented). Further, for example, the interface apparatus 206 receives the respective signals from the sensors 212 such as a vehicle speed sensor.

The communication apparatus 202 is communication means for performing infrared communication or wireless communication. The communication apparatus 202 receives the POI information. Further, the communication apparatus 202 receives traffic information such as traffic information from the VICS via a radio beacon, an optical beacon or FM multiplex broadcast.

The GPS receiver 207 which detects GPS signals from the GPS satellites, the gyro sensor 208 which detects a traveling direction of the vehicle, and the sensors 212 such as a vehicle speed sensor which detect the vehicle speed are apparatuses which detects the current position of the vehicle. A range of a map to be displayed, a starting point from which the route search is performed, etc., are determined based on the current position of the vehicle detected by the current position detecting apparatuses. The current position is also displayed on the map.

The input apparatus is an apparatus with which the operator performs various input operations via operation screens. The input apparatus 209 includes touch panel switches which are provided to be superposed on the display screen of the display apparatus 210, a joystick by means of which a user instructs movements of a cursor and scrolls of the display screen, etc. Further, the input apparatus 209 may be a remote control switch or a hardware key provided around the display screen.

The display apparatus 210 is an apparatus which displays various data, such as image data stored temporarily in an image memory (not shown) from the CPU 201, on the display screen. For example, an own vehicle position mark which indicates the own vehicle position, route information, guidance information, etc., are displayed together with the road map on the display screen of the display apparatus 210. Further, operation screens with which the operator demands actions and performs settings of the functions of the car navigation apparatus 2 are also displayed on the display apparatus 210.

The speech output apparatus 211 is a speaker, for example, and outputs sound and speech. Information such as route guidance, traffic information, etc., is output with speech.

The portable information terminal 3 has a hardware configuration which is well-known per se. The portable information terminal 3 may be a PDA (Personal Digital Assistant), a mobile phone, a portable personal computer, etc. The portable information terminal 3 has functions described hereafter. Further, the portable information terminal 3 has communication means such as Bluetooth communication, infrared communication, etc., for communicating with the car navigation apparatus 2.

[Function]

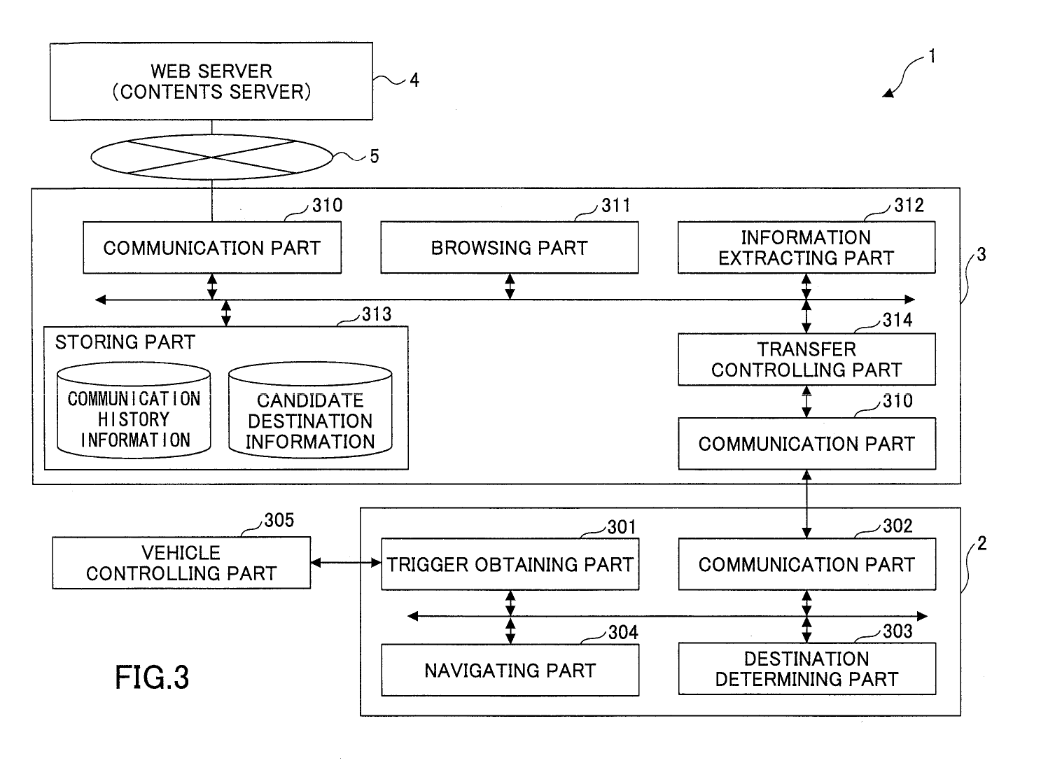

FIG. 3 is a functional block diagram illustrating main components of an embodiment of the car navigation system 1 according to the present invention including the car navigation apparatus 2 and the portable information terminal 3. The portable information terminal 3 extracts and obtains potential destination information from the web server 4, which is a contents server, and transmits the potential destination information to the car navigation apparatus 2. The car navigation apparatus 2 performs destination determination and setting of a destination based on the potential destination information transmitted from the portable information terminal 3.

In the following, details will be described.

[Car Navigation Apparatus]

The car navigation apparatus 2 according to the embodiment has a configuration including a trigger obtaining part 301, a communication part 302, a destination determining part 303 and a navigating part 304.

The trigger obtaining part 301 obtains an engine operation signal from the vehicle controlling part 305 when the driver enters the vehicle on which the car navigation apparatus 2 according to the embodiment is installed and starts the engine (i.e., turns ACC on). When the trigger obtaining part 301 receives the engine operation signal, the trigger obtaining part 30 is triggered to output a trigger signal to the communication part 302.

The communication part 302 issues a communication request to the portable information terminal 3 to establish communication, when the trigger signal is output from the trigger obtaining part 30. Further, the communication part 302 receives the potential destination information used in setting of a destination in the car navigation apparatus 2. It is noted that the potential destination information is described below in detail.

The destination determining part 303 determines a destination to be set in the car navigation apparatus 2 based on the potential destination information received from the communication part 302. The determination of a destination is described below in detail.

The navigating part 304 sets route guidance to the destination determined in the destination determining part 303. The navigating part 304 corresponds to destination setting means.

It is noted that in fact the above described respective functions are implemented by a car navigation program executed by the CPU 201.

[Portable Information Terminal]

The portable information terminal 3 according to the embodiment has a configuration including a communication part 310, a browsing part 311, a information extracting part 312, a storing part 313 and a transfer controlling part 314.

The communication part 310 performs communications with a telephone communication network and the Internet. For example, the communication part 310 provides communication functions such as a telephone, Internet access, e-mail, etc. Further, the communication part 310 performs transmission of the potential destination information with infrared communication, etc., for example.

The browsing part 311 provides browser functions (browsing, searching, information transmission, etc.) with respect to the contents of the web server 4. For example, the browsing part 311 accesses the web server 4 to search for, obtain and display the information (including POI). The browsing part 311 may be implemented by the existing Internet browser (software), etc.

The information extracting part 312 extracts and obtains the potential destination information from the information searched for, obtained and displayed in the browsing part 311. Specifically, the information extracting part 312 extracts and obtains the destination information, such as a name of a candidate destination (a name of a facility, a name of a restaurant, for example), location information, a telephone number, an e-mail address, etc., by analyzing a character string, a tag (identifier), etc., from a hyper text (HTML, etc.) displayed on the screen. For example, when the user (the operator of the portable information terminal 3) finds out the destination the user desires to set in the car navigation apparatus 2 as a destination, the destination information is extracted and obtained by an operation of the user such as pressing down of a predetermined button on the display screen. The extracted and obtained information is included in the potential destination information and stored in the storing part 313.

Further, the information extracting part 312 extracts and obtains the information (including an input form) input by the user via the display screen. The extracted and obtained information is included in the potential destination information and stored in the storing part 313. For example, when a restaurant, a facility, etc., is searched for and displayed on the screen, and a reservation at the restaurant is made utilizing a reservation form or the like on the screen, the information extracting part 312 extracts and obtains day and time information of the reservation. Alternatively, in the case of a connection guide of transportation, the day and time information, the destination information, etc., which is input at the time of searching, is extracted and obtained.

Further, the information extracting part 312 extracts and obtains communication history information, which corresponds to the telephone number or the e-mail mail address obtained previously, from the communication history information stored in the storing part 313. The extracted and obtained information is included in the potential destination information and stored in the storing part 313. For example, if the telephone communication with the restaurant is performed by calling the telephone number of the restaurant described on the screen searched for using the portable information terminal 3, the telephone number is stored in the communication history (including the day and time, a communication time, etc.) which in turns is included in the potential destination information and stored in the storing part 313. Further, the e-mail transmitted is stored in the communication history (including the day and time, a destination e-mail address, contents, etc.) which in turn is included in the potential destination information and stored in the storing part 313.

The storing part 313 stores the communication history information, which is a history of the communication of the portable information terminal 3, and the potential destination information extracted and obtained by the information extracting part 312.

The transfer controlling part 314 performs control whether to automatically transmit the potential destination information from the portable information terminal 3 to the car navigation apparatus 2. For example, when there is a communication request from the car navigation apparatus 2, the transfer controlling part 314 performs control whether to automatically transmit the potential destination information from the portable information terminal 3.

It is noted that in fact the above described respective functions are implemented by a portable information terminal program executed by a CPU (not shown).

[Operations]

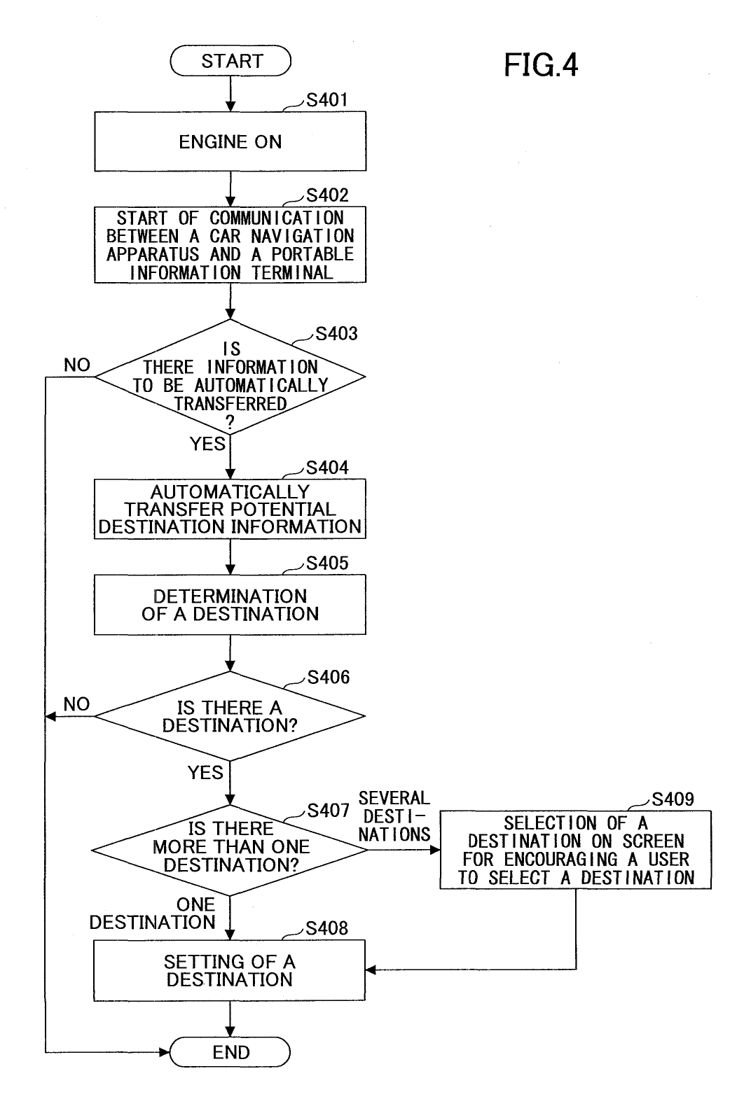

FIG. 4 is a flowchart illustrating an example of a main process implemented by the embodiment of the car navigation system 1. The following is explained with reference to FIG. 4.

In step 401, the engine of the vehicle is started. Specifically, the trigger obtaining part 301 obtains an engine operation signal from the vehicle controlling part 305 when the driver enters the vehicle on which the car navigation apparatus 2 according to the embodiment is installed and starts the engine (i.e., turns ACC on).

The process routine goes to step 402 in which the communication between the car navigation apparatus 2 and the portable information terminal 3 is started. When the trigger obtaining part 301 of the car navigation apparatus 2 receives the engine operation signal, the trigger obtaining part 30 is triggered to output a trigger signal to the communication part 302. The communication part 302 issues a communication request to the portable information terminal 3 to establish the communication, when the trigger signal is output from the trigger obtaining part 30.

The process routine goes to step 403 in which if there is the potential destination information to be automatically transferred, the process routine goes to step 404. If there is no potential destination information to be automatically transferred, the process routine terminates.

The process routine goes to step 404 in which the transfer controlling part 314 of the portable information terminal 3 automatically transfers the potential destination information from the portable information terminal 3 to the car navigation apparatus 2.

The process routine goes to step 405 in which the destination determining part 303 of the car navigation apparatus determines a destination to be set in the car navigation apparatus 2 based on the potential destination information received from the communication part 302. The determination of a destination is described below in detail.

The process routine goes to step 406 in which if there is a destination to be set in step 405, the process routine goes to step 407. If there is no destination to be set, the process routine comes to an end.

The process routine goes to step 407 in which if there is a destination (one location) to be set, the process routine goes to step 408. If there are several destinations (more than one destination) to be set, the process routine goes to step 409.

The process routine goes to step 408 in which the navigating part 304 sets route guidance to the destination to be set determined in the destination determining part 303. The car navigation apparatus 2, in which setting of a destination is completed, performs the route guidance to guide the vehicle to the destination with a display, a message, etc.

On the other hand, if the process routine goes to step 409, a screen for encouraging the user to select the destination to be set among the several destinations (i.e., candidate destinations) is displayed on the display apparatus 210 of the car navigation apparatus 2, etc. The user selects one destination among the several destinations (i.e., candidate destinations). The process routine goes to step 408 in which the destination selected by the user is set. It is noted that the case where the several destinations (i.e., candidate destinations) are selected by the user is the case where in the destination determining part 303 a destination to be set cannot be determined and thus the several destinations (i.e., candidate destinations) are determined.

[Destination Determination]

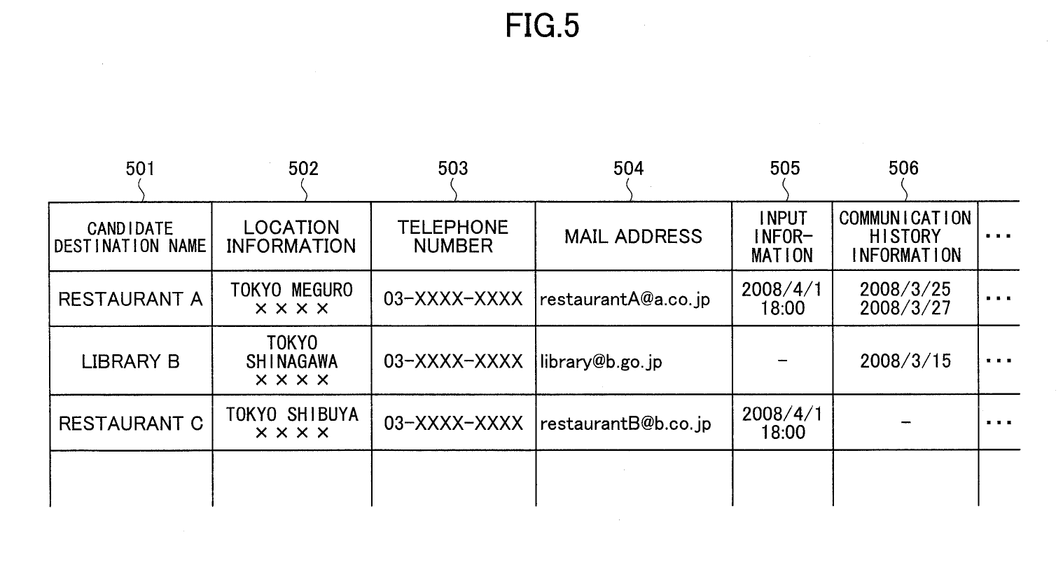

FIG. 5 is a diagram illustrating an example of potential destination information. The potential destination information according to the embodiment is information which is stored in the storing part of the portable information terminal 3 and passed to the destination determining part 303 of the car navigation apparatus 2. The destination determining part 303 of the car navigation apparatus 2 performs determination of a destination to be set in the car navigation apparatus 2, based on the potential destination information. Hereafter, the determination of a destination is described in detail with reference to FIG. 5.

The potential destination information is obtained by the information extracting part from the portable information terminal 3, as described above. The potential destination information includes information which is extracted from the display screen, such as a candidate destination name 501 (a name of a facility, a name of a restaurant, for example), location information (latitude, longitude, etc.) 502, a telephone number (and a facsimile number) 503, an e-mail address 504, etc., and input information (input day and time information) 505 such as reservation information input via an input form, search information input via a search form and communication history information 505 corresponding to the obtained telephone number and the obtained e-mail address. It is noted that the communication history information 505 is not communication history information which is stored in the storing part 313 (i.e., all the communication history of the portable information terminal) but communication history information 505 which corresponds to the telephone number and the e-mail address of the (potential) destination information and is extracted and obtained from the communication history information stored in the storing part 313.

In the following, determination of a destination will be described. The determination is performed based on day and time when the user enters the vehicle, day and time when the user should reach the destination, and a probability value representing a degree or an extent of a probability that the user goes to the destination. The day and time when the user enters the vehicle correspond to the day and time when the car navigation apparatus 2 receives the potential destination information from the portable information terminal 3.

The day and time when the user should reach the destination is determined based on the day and time information of the input information. For example, if the reservation of the restaurant is made utilizing the reservation form on the screen, the day and time when the user should reach the destination is the day and time of the reservation of the restaurant. In the case of the connection guide of transportation, the day and time when the user should reach the destination is the day and time which is input at the time of searching. It is noted that the connection guide of transportation is not the connection guide of public transportation such as a train, a bus, etc., but is such a connection guide of transportation in which the user moves by a car to a station on the way and then changes to a train, for example.

The probability value representing a degree or an extent of a probability that the user goes to the destination is calculated from the communication history information 506 which corresponds to the obtained telephone number or the obtained e-mail address. The probability value representing a degree or an extent of a probability that the user goes to the destination is a value which represents how high the probabilities of going to the respective candidate destinations are in the case where there are several candidate destinations. For example, if the telephone communication with the restaurant is performed by calling the telephone number of the restaurant (further, the number of telephone communication performed), it is determined that a probability of going to the candidate destination is high. Further, it is determined that a probability of going to the candidate destination corresponding to the (destination) e-mail address to which the e-mail is transmitted (further, the number of e-mails transmitted) is high. Weighing of the probability value of each action may be predetermined according to a content of the corresponding action. If there are several candidate destinations determined to be set, the candidate destination with a high probability value is determined as the destination to be set. On the other hand, if the probability value is the same with respect to the several candidate destinations, the screen for encouraging the user to select the destination to be set among the several destinations (i.e., candidate destinations) is displayed on the display apparatus 210 of the car navigation apparatus 2, etc. The user selects one destination among the several destinations (i.e., candidate destinations) and the destination selected by the user is set (see step 409 in FIG. 4).

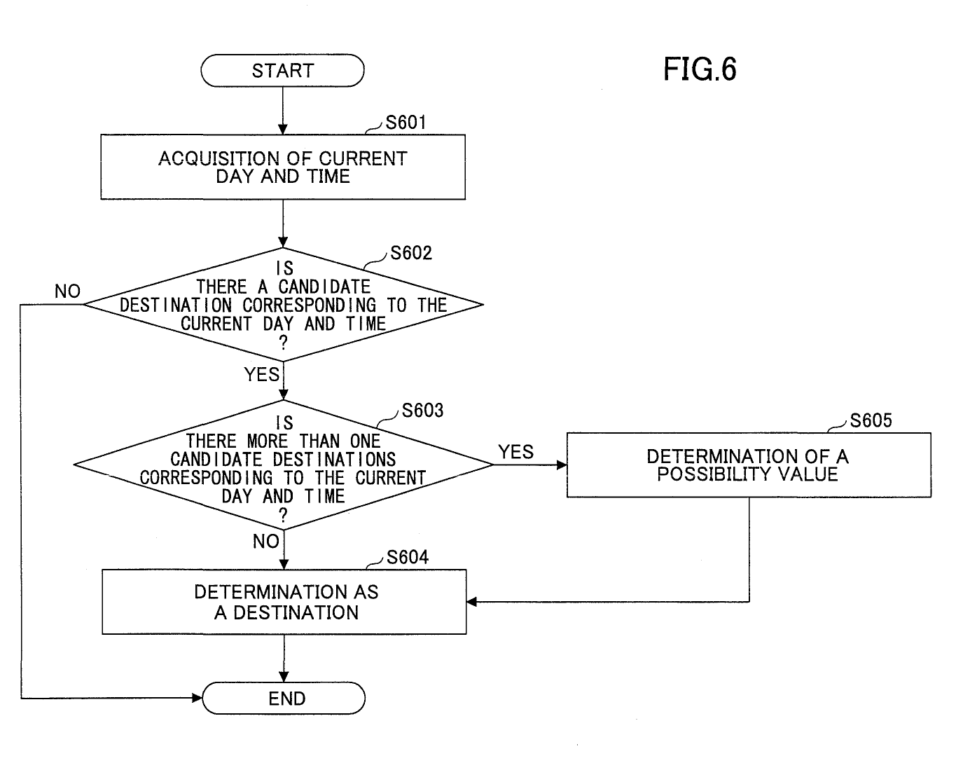

Next, the determination of the destination is described with reference to a flowchart show in FIG. 6. This description is related to a scene in which the potential destination information is passed to the destination determining part 303 of the car navigation apparatus 2 and the destination determining part 303 performs determination of a destination to be set in the car navigation apparatus 2, based on the potential destination information.

In step 601, the destination determining part 303 obtains the current day and time. For example, the destination determining part 303 obtains day and time such as “17:00 Apr. 1, 2008”.

The process routine goes to step 602 in which it is determined whether there is a candidate destination corresponding to the current day and time (17:00 Apr. 1, 2008). The destination determining part 303 refers, based on the candidate destination, to the day and time when the user should reach the destination and determines a destination considering the current day and time. Specifically, if with respect to a certain candidate destination the day and time when the user should reach the destination is “18:00 Apr. 1, 2008”, it is determined that a probability that the user (driver) goes to this candidate destination is high and the candidate destination is determined as the destination. It is noted that it is possible to determine considering a location of the destination (location information) and a predicted arrival time at the destination which can be obtained utilizing the navigating function of the navigating part 304.

The process routine goes to step 603 in which if there are several destinations determined, the process routine goes to step 605. If there is a single destination determined, the process routine goes to step 604.

The process routine goes to step 605 in which a destination is determined among the several destinations based on the probability values, if there are several destinations determined. For example, “a restaurant A” and “a restaurant C” are determined as destinations, because both have the input information 505 based on which the day and time when the user should reach the destination is “18:00 Apr. 1, 2008”. However, the probability value of “a restaurant A” is determined to be higher based on the communication history information (i.e., telephone communication performed twice). As a result of this, “a restaurant A” is determined as the destination. Then, the process routine goes to step S604.

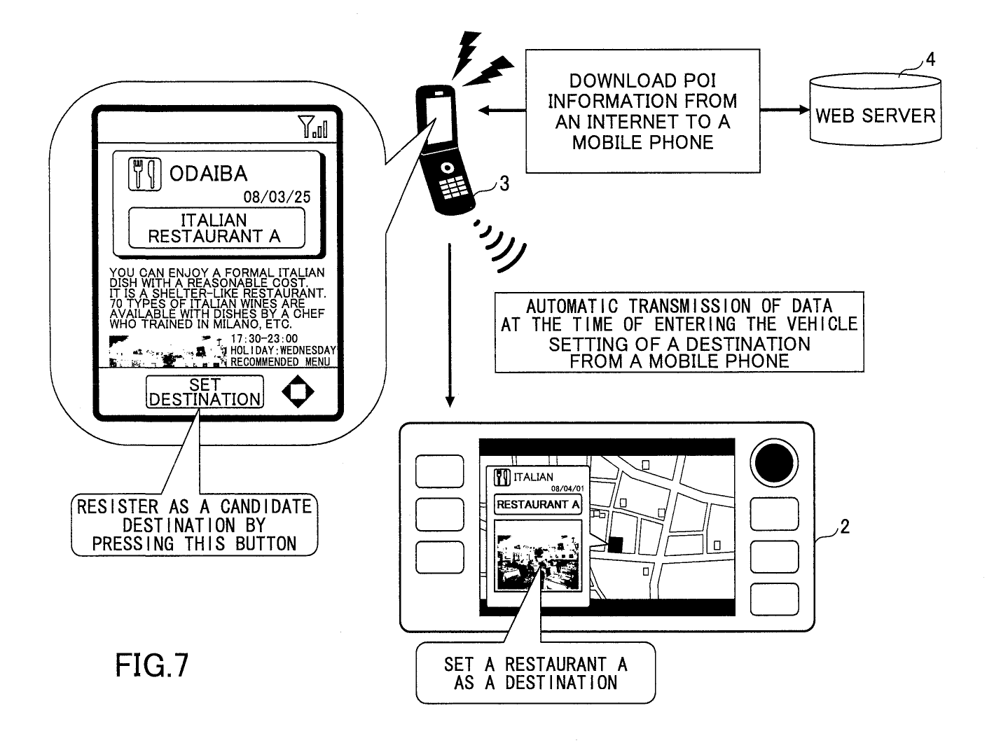

In step 604, the destination is determined (set). It is noted that if there is no candidate destination corresponding to the current day and time in step 602, there is no destination to be set in the car navigation apparatus 2, and thus the process routine terminates without performing any further process (i.e., setting of the destination is not performed). In FIG. 7, an example of an operation for setting a destination in the car navigation system 1 according to the embodiment is shown.

According to the embodiment, as described above, the candidate destination information (information on the candidate destination) from the portable information terminal 3 is automatically transmitted and whether the destination is automatically set is determined. Therefore, convenience in setting the destination in the car navigation apparatus 2 is improved. Further, since the determination of the destination to which the user goes has a high probability, the destination with high accuracy is set and useless setting of a destination, changing of the setting, etc., are prevented, which reduce burdensomeness. In other words, it is possible to provide a car navigation apparatus and a car navigation system which automatically receives destination information from a portable information terminal and performs setting of a destination to which a user goes from this time on with a high probability.

[Variation]

Next, a variant of the above described car navigation apparatus 1 is described. According to the present variant, the car navigation system is configured in such a manner that the destination determining function (corresponding to destination determining part 303) is provided in the portable information terminal 3. According to this arrangement, the car navigation apparatus 2 becomes an existing car navigation apparatus 2 to which the destination information is transmitted from the portable information terminal 3 and which sets the destination concerning the transmitted destination information. With this arrangement, since the present invention can be implemented by installing the functions related to the present invention only at the side of the portable information terminal 3, the present invention can be applied to the existing car navigation apparatus which is already installed. This is described below. It is noted that an overlapped description may be omitted.

[Function]

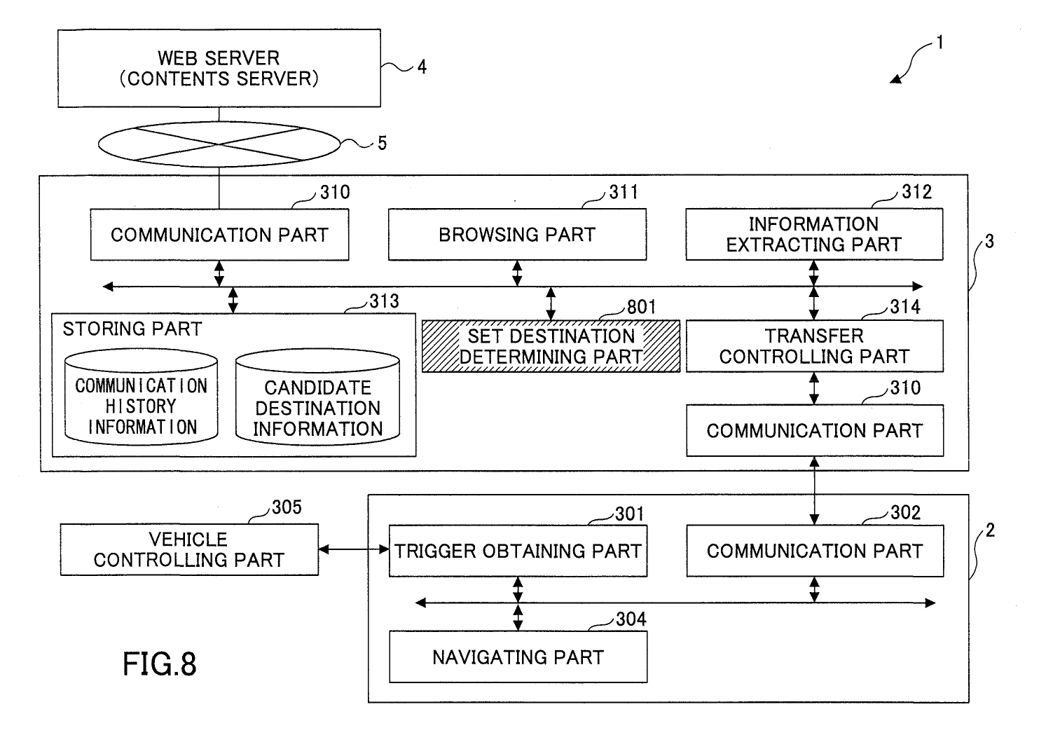

FIG. 8 is a functional block diagram illustrating main components of an embodiment of the car navigation system 1 according to the present invention including the car navigation apparatus 2 and the portable information terminal 3. The portable information terminal 3 extracts and obtains the potential destination information from the web server 4, which is a contents server, via a mobile phone network/Internet 5, and determines a destination to be set in the car navigation apparatus 2 (referred to as a set destination, hereafter) based on the potential destination information. Then, the portable information terminal 3 transmits information on the determined set destination (referred to as set destination information) to the car navigation apparatus 2. The car navigation apparatus 2 performs setting of a destination based on the set destination information transmitted from the portable information terminal 3. This is described below.

[Car Navigation Apparatus]

The car navigation apparatus 2 according to the variant has a configuration including a trigger obtaining part 301, a communication part 302, and a navigating part 304. Here, the trigger obtaining part 301 is as described above and thus its explanation is omitted.

The communication part 302 issues a communication request to the portable information terminal 3 to establish communications, when the trigger signal is output from the trigger obtaining part 30. Further, the communication part 302 receives the set destination information used in setting of a destination in the car navigation apparatus 2.

The navigating part 304 sets route guidance to the destination based on the set destination information transmitted from the portable information terminal 3.

[Portable Information Terminal]

The portable information terminal 3 according to the variant has a configuration including a communication part 310, a browsing part 311, a information extracting part 312, a storing part 313, a transfer controlling part 314 and a set destination determining part 801. Here, the communication part 310, the browsing part 311, the information extracting part 312 and the storing part 313 are as described above and thus their explanation is omitted.

The transfer controlling part 314 performs control whether to automatically transmit the set destination information from the portable information terminal 3 to the car navigation apparatus 2. For example, when there is a communication request from the car navigation apparatus 2, the transfer controlling part 314 performs control whether to automatically transmit the set destination information from the portable information terminal 3.

The set destination determining part 801 according to the variant determines the destination to be set in the car navigation apparatus 2 (i.e., the set destination) based on the potential destination information extracted and obtained by the information extracting part 312. The set destination determining part 801 corresponds to set destination determining means. It is noted that determination of the set destination is described below in detail.

[Operations]

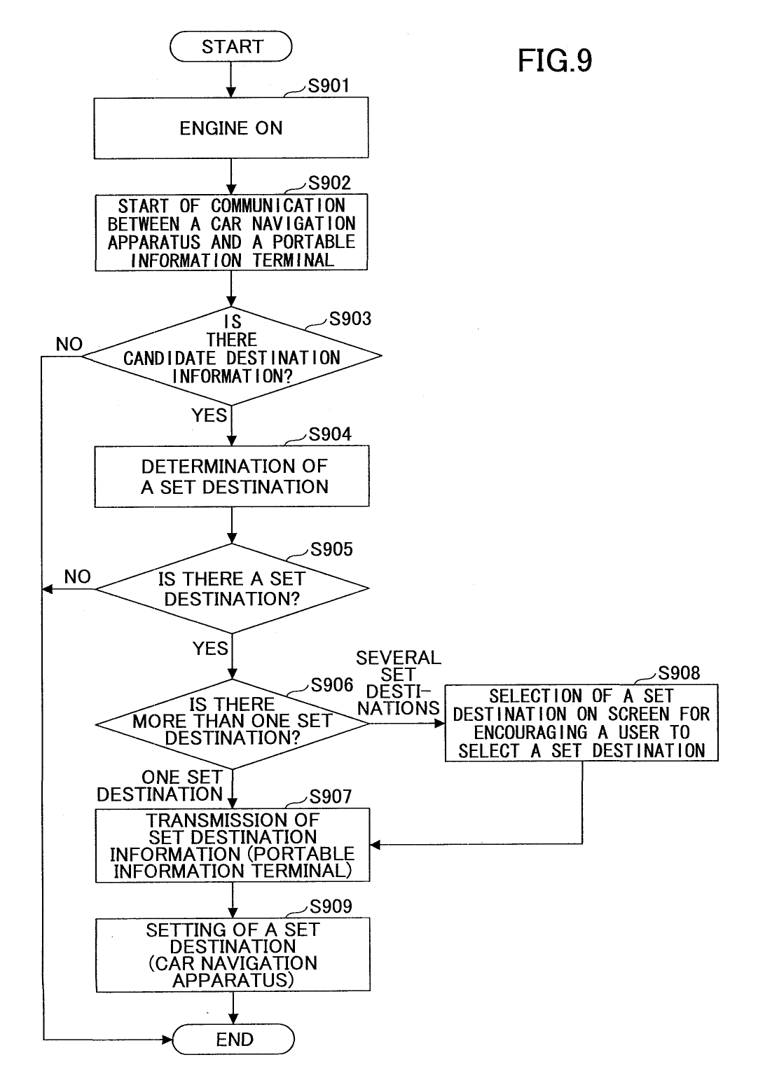

FIG. 9 is a flowchart illustrating an example of a main process implemented by the variant of the car navigation system 1. The following is explained with reference to FIG. 9.

In step 901, the engine of the vehicle is started. Specifically, the trigger obtaining part 301 obtains an engine operation signal from the vehicle controlling part 305 when the driver enters the vehicle on which the car navigation apparatus 2 according to the variant is installed and starts the engine (i.e., turns ACC on).

The process routine goes to step 902 in which the communication between the car navigation apparatus 2 and the portable information terminal 3 is started. When the trigger obtaining part 301 of the car navigation apparatus 2 receives the engine operation signal, the trigger obtaining part 30 is triggered to output a trigger signal to the communication part 302. The communication part 302 issues a communication request to the portable information terminal 3 to establish the communication, when the trigger signal is output from the trigger obtaining part 30.

The process routine goes to step 903 in which if there is the potential destination information (in the storing part 313), the process routine goes to step 904. If there is no potential destination information, the process routine comes to an end.

The process routine goes to step 904 in which if there is the potential destination information when the communication requests is issued to the portable information terminal 3, the set destination determining part 801 determines the destination to be set in the car navigation apparatus 2 (i.e., the set destination) based on the potential destination information extracted and obtained by the information extracting part 313. The determination of the set destination is described below in detail.

The process routine goes to step 905 in which if there is the set destination as a result of the determination by the set destination determining part 801, the process routine goes to step 906. If there is no set destination, the process routine comes to an end.

The process routine goes to step 906 in which if there is a set destination (one location), the process routine goes to step 907. If there are several set destinations (more than one set destination), the process routine goes to step 908.

The process routine goes to step 907 in which the communication part 310 of the portable information terminal 3 transmits the set destination information to the car navigation apparatus 2.

On the other hand, if the process routine goes to step 908, a screen for encouraging the user to select the set destination among the several destinations (i.e., candidate set destinations) is displayed on the display apparatus (not shown) of the portable information terminal 3, etc. The user selects one set destination among the several destinations (i.e., candidate set destinations). If the selection is performed, the set destination is determined, and thus the process routine goes to step 907. It is noted that the case where the set destination is selected by the user is the case where in the destination determining part 303 a set destination cannot be determined and thus the several destinations (i.e., candidate set destinations) are determined.

The process routine goes to step 909 in which the navigating part 304 sets route guidance (sets the destination) based on the received set destination information. The car navigation apparatus 2, in which setting of a destination is completed, performs the route guidance to guide the vehicle to the destination with a display, a message, etc.

[Set Destination Determination]

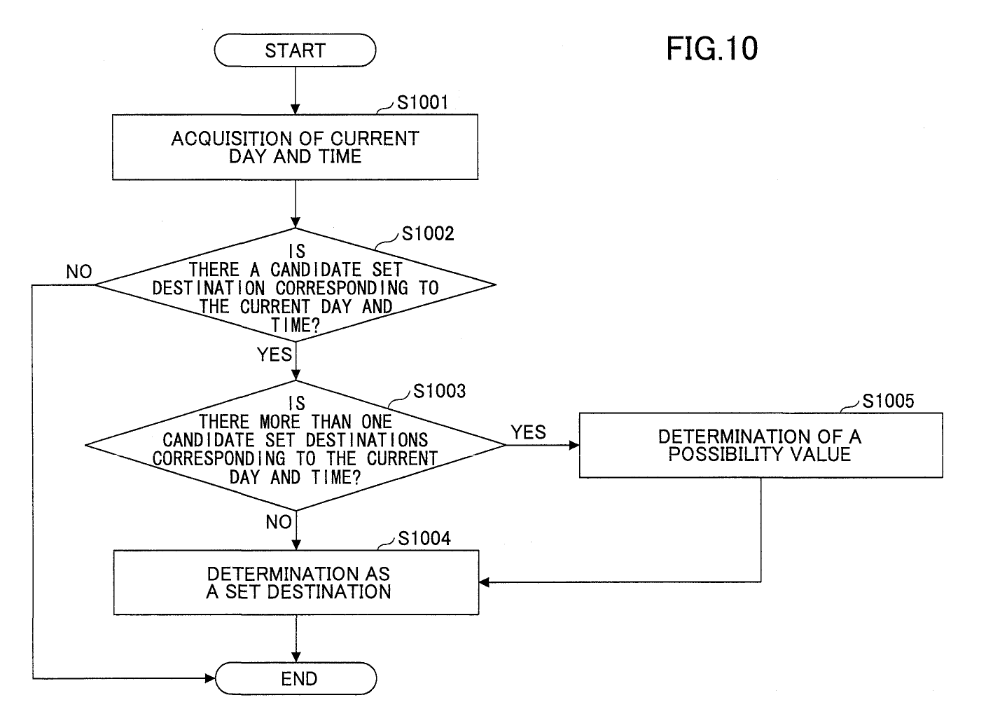

Next, the determination of the set destination is described with reference to a flowchart show in FIG. 10. This description is related to a scene in which the set destination determining part 801 of the portable information terminal 3 performs the determination of the set destination to be transmitted to the car navigation apparatus 2, based on the potential destination information.

In step 1001, the set destination determining part 801 obtains the current day and time. For example, the set destination determining part 801 obtains day and time such as “17:00 Apr. 1, 2008”.

The process routine goes to step 1002 in which it is determined whether there is a candidate set destination corresponding to the current day and time (17:00 Apr. 1, 2008). The set destination determining part 801 refers to the day and time when the user should reach the destination and determines a set destination considering the current day and time. Specifically, if with respect to a certain candidate set destination the day and time when the user should reach the destination is “18:00 Apr. 1, 2008”, it is determined that a probability that the user (driver) goes to this destination is high and the destination is determined as the set destination.

The process routine goes to step 1003 in which if there are several set destinations determined, the process routine goes to step 1005. If there is a set destination determined, the process routine goes to step 1004.

The process routine goes to step 1005 in which a set destination is determined among the several set destinations based on the probability values, if there are several set destinations determined. The detail of this process is as described above and thus is omitted here. Then, the process routine goes to step S1004.

The process routine goes to step 1004 in which the determined set destination is determined (confirmed). It is noted that if there is no candidate set destination corresponding to the current day and time in step 1002, there is no set destination to be transmitted to the car navigation apparatus 2, and thus the process routine terminates without performing any further process. In FIG. 7, an example of setting of a destination in the car, navigation system 1 according to the variant is shown.

According to the variant, as described above, since the set destination information from the portable information terminal 3 is automatically transmitted, convenience in setting the destination in the car navigation apparatus 2 is improved. Further, since the set destination information is automatically transmitted after the determination of the destination to which the user goes with a high probability is performed in the portable information terminal 3, the destination with high accuracy is set in the car navigation apparatus 2 and useless setting of a destination, changing of the setting, etc., are prevented, which reduce burdensomeness. In other words, it is possible to provide a portable information terminal which automatically transmits destination information on a destination, to which a user goes from this time on with a high probability, to perform setting of a destination in the car navigation apparatus. Further, according to the configuration of the variant, the car navigation apparatus 2 may be an existing car navigation apparatus 2 to which the destination information is transmitted from the portable information terminal 3 and which sets the destination concerning the transmitted destination information. Further, since the present invention can be implemented by installing the functions related to the present invention only at the side of the portable information terminal 3, the present invention can be applied to the existing car navigation apparatus which is already installed.

The present invention is disclosed with reference to the preferred embodiments. However, it should be understood that the present invention is not limited to the above-described embodiments, and variations and modifications may be made without departing from the scope of the present invention.

The present application is based on Japanese Priority Application No. 2008-094962, filed on Apr. 1, 2008, the entire contents of which are hereby incorporated by reference.

### INDUSTRIAL APPLICABILITY

The present invention is applicable to industries such as car manufacturing, car component manufacturing, etc.

1. A car navigation apparatus which is installed in a vehicle and performs a setting of a destination to be guided based on information received from a portable information terminal, said car navigation apparatus comprising:
receiving means for receiving, from the portable information terminal, destination information, which is obtained utilizing a contents server to which the portable information terminal is connected via a network, and date and time information, which is input at the time of utilizing the contents server; and
destination setting means for setting the destination based on the destination information and the date and time information received by the receiving means,
wherein the receiving means receives communication history information related to the destination information, said communication history information being obtained by the portable information terminal from a communication history of the portable information terminal, and
the destination setting means sets the destination based on the destination information, the date and time information and the communication history information.

2. (canceled)

3. The car navigation apparatus claimed in claim 1, wherein the receiving means automatically receives the information from the portable information terminal when an engine of the vehicle is started.

4. A portable information terminal which transmits information on contents which said portable information terminal obtains using a contents server to which said portable information terminal is connected via a network, and performs a destination setting of a navigation apparatus, said portable information terminal comprising:
information extracting means for extracting destination information from information on contents, and day and time information, which is input at the time of utilizing the contents server;
set destination determining means for determining a destination set in the car navigation apparatus based on the destination information and the day and time information extracted by the information extracting means; and
transmitting means for transmitting information on the set destination to the car navigation apparatus, said set destination being determined by the set destination determining means,
wherein the information extracting means extracts communication history information related to the destination information, said communication history information being extracted from a communication history of the portable information terminal; and
the set destination determining means determines the set destination based on the destination information, the date and time information and the communication history information.

5. (canceled)

6. The portable information terminal claimed in claim 4, wherein the transmitting means automatically transmits the information extracted by the information extracting means when the transmission is demanded by the car navigation apparatus.

7. A car navigation system comprising a portable information terminal which transmits information on contents which said portable information terminal obtains using a contents server to which said portable information terminal is connected via a network; and a navigation apparatus which performs a setting of a destination to be guided based on the information on contents which is received from the portable information terminal,
wherein the portable information terminal comprising:
information extracting means for extracting destination information from information on contents, and day and time information, which is input at the time of utilizing the contents server; and
transmitting means for transmitting the destination information and the day and time information to the car navigation apparatus, said set destination being extracted by the information extracting means, and
the car navigation apparatus comprising:
receiving means for receiving the destination information and the day and time information from the portable information terminal; and
destination setting means for setting the destination based on the destination information and the date and time information received by the receiving means,
wherein in the portable information terminal:
the information extracting means extracts communication history information related to the destination information, said communication history information being extracted from a communication history of the portable information terminal; and
the transmitting means transmits the communication history information, and in the car navigation apparatus:
the receiving means receives the communication history information; and
the destination setting means sets the destination based on the destination information, the date and time information and the communication history information.

8. (canceled)

9. The car navigation system claimed in claim 7, wherein the transmitting means of the portable information terminal automatically transmits the information extracted by the information extracting means when an engine of the vehicle is started.
